(19) United States
(12) Patent Application Publication
(10) Pub. No.: US 2024/0204474 A1
(43) Pub. Date: Jun. 20, 2024

(54) DEVICE FOR GENERATING LASER RADIATION

(71) Applicant: TOPTICA Photonics AG, Gräfelfing (DE)

(72) Inventors: Sarah HUTTER, Konstanz (DE); Alfred LEITENSTORFER, Konstanz (DE); Ali SEER, München (DE); Rafal WILK, München (DE)

(73) Assignee: TOPTICA Photonics AG, Gräfelfing (DE)

(21) Appl. No.: 18/542,888

(22) Filed: Dec. 18, 2023

(30) Foreign Application Priority Data
Dec. 16, 2022 (DE) 10 2022 133 719.7
Jan. 20, 2023 (DE) 10 2023 101 424.2

(51) Int. Cl. H01S 3/131; H01S 3/04; H01S 3/08; H01S 3/1112; H01S 3/16

(52) U.S. Cl. CPC H01S 3/1312; H01S 3/0404; H01S 3/08013; H01S 3/1112; H01S 3/1608

(57) ABSTRACT

The disclosure relates to a device for generating pulsed laser radiation, having a laser resonator which contains a laser-active medium (EDF1, EDF2), a pump light source which optically pumps the laser-active medium (EDF1, EDF2) at a pump power (P), and a mode coupling device which is intended to effect phase coupling of the modes of the laser radiation circulating in the laser resonator, so that the spectrum of the laser radiation forms a frequency comb. The disclosure also relates to a method for designing or operating such a device. The disclosure proposes that phase noise of the frequency comb, i.e. the width of spectral lines of the frequency comb, is minimized at a predetermined useful frequency by adjusting the frequency of the pump power fixed point (vfix_{,pump}) of the frequency comb. For this purpose, at least two of the parameters pump power (P), group delay dispersion of the laser resonator, non-linearity of the laser resonator and amplification of the laser-active medium (EDF1, EDF2) are optimized in an iterative process until the pump power fixed point (vfix_{,pump}) is set to the desired frequency and the quadratic increase in the width of the spectral lines of the frequency comb with the frequency spacing of the spectral lines from the useful frequency is simultaneously minimized. The disclosure provides a fiber-based laser device for generating an fs frequency comb with maximum passive stability and a simple and compact design at the same time. The achievable linewidths of the comb lines lie over a broad spectral range in the kHz and sub-kHz range.

### RELATED APPLICATION

This application claims the benefit of priority of German Patent Application Nos. 10 2023 101 424.2 filed on Jan. 20, 2023 and 10 2022 133 719.7 filed on Dec. 16, 2022, the contents of which are incorporated by reference as if fully set forth herein in their entirety.

### FIELD AND BACKGROUND OF THE INVENTION

The disclosure relates to a device for generating pulsed laser radiation, having a laser resonator which contains a laser-active medium, a pump light source which optically pumps the laser-active medium at a pump power, and a mode coupling device which is intended to effect phase coupling of the modes of the laser radiation circulating in the laser resonator, so that the spectrum of the laser radiation forms a frequency comb.

The disclosure also relates to a method for designing and/or operating a laser device having a laser resonator which contains a laser-active medium, a pump light source which optically pumps the laser-active medium at a pump power, and a mode coupling device which is provided to effect phase coupling of the modes of the laser radiation circulating in the laser resonator, so that the spectrum of the laser radiation forms a frequency comb.

Femtosecond pulsed lasers with emission spectra in the form of optical frequency combs are among the most precise measuring instruments known. Such laser devices enable a wide range of applications in a variety of fields, from high- precision spectroscopy and high-precision metrology to quantum physics in the time domain.

An optical frequency comb (see Hall, J. L., Nobel Lecture: “Defining and measuring optical frequencies”, Rev. Mod. Phys. 78, 1279-1295, 2006; Hänsch, T. W., Nobel Lecture: “Passion for precision”, Rev. Mod. Phys. 78, 1297-1309, 2006), hereinafter referred to as OFC (Optical Frequency Comb), is typically generated by means of a mode-locked laser. The OFC consists of a large number of equidistant spectral lines (comb lines), which are spaced apart by the repetition rate fᵣ of the laser resonator. The entire OFC is shifted relative to the origin of the frequency axis by the offset frequency f_{CEO}, the so-called carrier envelope frequency. Consequently, the frequency position of each comb line fₙ is defined by its mode number n and two characteristic radio frequencies. This relationship is summarized in the frequency comb equation:

$${f}_{n} = {f}_{CEO} + n \times {f}_{r}$$

Since both fᵣ and f_{CEO} can be determined very precisely by electronic counting, OFCs represent a unique link between the high frequency and optical domains. Nowadays, OFCs generating laser devices are often realized on the basis of optical fibers, which for example makes them stand out for their compactness and stability. Maximizing the passive stability of OFCs generating laser devices is essential to exploit their full potential in fundamental research and industrial applications.

The phase noise properties of OFCs determine their performance in various applications, such as in optical atomic clocks and in ultra-precision spectroscopy.

Therefore, there is a great demand for OFCs with extremely narrow linewidths of the individual comb lines. Theoretical studies dealing with noise in mode-locked lasers (see Haus, H. A. & Mecozzi, A.: “Noise of Mode-locked Lasers”, IEEE J. Quantum Electron. 29, 983-996, 1993; Haus, H. A.: “Noise of Stretched Pulse Fiber Lasers: Part I-Theory”, IEEE J. Quantum Electron. 33, 649-659, 1997; Paschotta, R.: “Noise of mode-locked lasers (Part II): timing jitter and other fluctuations”. Appl. Phys. B Lasers Opt. 79, 163-173, 2004), predict that minimizing the dispersion in the laser resonator reduces the phase noise of the repetition frequency fᵣ, the so-called timing jitter. However, the known studies only characterize a specific comb line and provide no information about the other modes of the OFCs.

### SUMMARY

The disclosure relates to a device for generating pulsed laser radiation, with a laser resonator containing a laser-active medium (EDF1, EDF2), a pump light source which optically pumps the laser-active medium (EDF1, EDF2) at a pump power (P), and a mode coupling device which is provided to effect phase coupling of the modes of the laser radiation circulating in the laser resonator, so that the spectrum of the laser radiation forms a frequency comb.

### BRIEF DESCRIPTION OF THE DRAWINGS

FIG. 1 shows a device for generating pulsed laser radiation (schematic);

FIG. 2 shows diagrams illustrating the effects of the stability of the pump power on the parameters of the OFC as a function of the pump power;

FIG. 3 shows diagrams illustrating the phase noise behavior of a laser device designed in accordance with the disclosure.

### DETAILED DESCRIPTION

The disclosure relates to a device of the type mentioned above in that phase noise of the frequency comb, i.e. the width of spectral lines of the frequency comb, is minimized at a predetermined useful frequency by adjusting the frequency of the pump power fixed point of the frequency comb.

In addition, the disclosure relates to a method of the type mentioned above in that phase noise of the frequency comb, i.e. the width of spectral lines of the frequency comb, is minimized at a predetermined useful frequency by adjusting the frequency of the pump power fixed point of the frequency comb.

The term “minimized” in the sense of the disclosure does not necessarily mean the precise setting of an absolute minimum of the phase noise. The term also includes an approximation to the minimum within the scope of what can be achieved in practice with reasonable effort.

The useful frequency is an optical frequency that results from the application of the laser device, i.e. where the generated laser radiation is used, e.g. for a spectroscopic examination.

In general, the spectral density of the phase noise S_{Δν} of a comb line at the frequency ν is given by

$${S}_{Δν , v} ( f ) = {f}_{r}^{2} [ {{S}_{rep}^{quant} ( v - {v}_{c} )}^{2} + {S}_{rep}^{env} ( f ) {( v )}^{2} + {S}_{rep}^{pump} ( f ) {( v - {v}_{fix , pump} )}^{2} ]$$

With laser resonators that have almost zero dispersion and are characterized by high circulating powers and spectrally broad laser pulses, fluctuations in the repetition frequency Sᵣₑₚ^{quant} caused by increased spontaneous emission (ASE) can be reduced to a minimum. The influence of the ambient noise Sᵣₑₚ^{env} can be reduced by shielding the laser resonator, i.e. by mechanically decoupling the laser resonator from the environment (e.g. by passive or active damping). Preferably, both contributions should be minimized for noise optimization. The third term Sᵣₑₚ^{pump} indicates the pump power-induced fluctuations of the repetition frequency. This is where the disclosure comes in, in that the frequency of the pump power fixed point is specifically set so that in result the line widths of the spectral lines of the OFCs, which are influenced by all three specified noise components, are minimized in the range of the desired useful frequency.

The approach of the disclosure is based on the qualitative access offered by the model of the so-called elastic band to the phase noise correlations between the comb lines of the OFCs. This model illustrates the comb lines fixed to a rubber band, which stretches and contracts due to fluctuations in fᵣ, while moving sideways with a change in f_{CEO}. For each fluctuating variable that influences the comb spectrum, there is a fixed frequency value, referred to as a fixed point, which is not affected by this “breathing” movement, i.e. the frequencies of the spectral lines near the fixed point remain unchanged. With increasing distance of the comb lines from the fixed point, the noise level increases quadratically (see McFerran, J. J., Swann, W. C., Washburn, B. R. & Newbury, N. R.: “Elimination of pump-induced frequency jitter on fiber-laser frequency combs”, Opt. Lett. 31, 1997-1999, 2006). The disclosure exploits this under the assumption, which is justified in practice, that the noise of the frequency comb is dominated by pump noise, i.e. noise of the pump light source, by specifically designing the laser device such that the pump power fixed point, i.e. the frequency in the spectrum of the OFCs that does not change with fluctuations in the pump power, is set such that the phase noise at the specified useful frequency is as low as possible, i.e. minimized. This makes it possible to generate ultra-stable laser pulses with a pulse duration in the fs range in a frequency range around the useful frequency.

### DETAILED DESCRIPTION OF THE DRAWINGS

By the location of the pump power fixed point, the disclosure determines, as explained above, which comb lines of the OFC are not or least broadened by fluctuation of the pump power, i.e. by pump noise. The ability to specifically select this spectral band is, according to the disclosure, decisive for providing OFCs with very low noise in a useful frequency range.

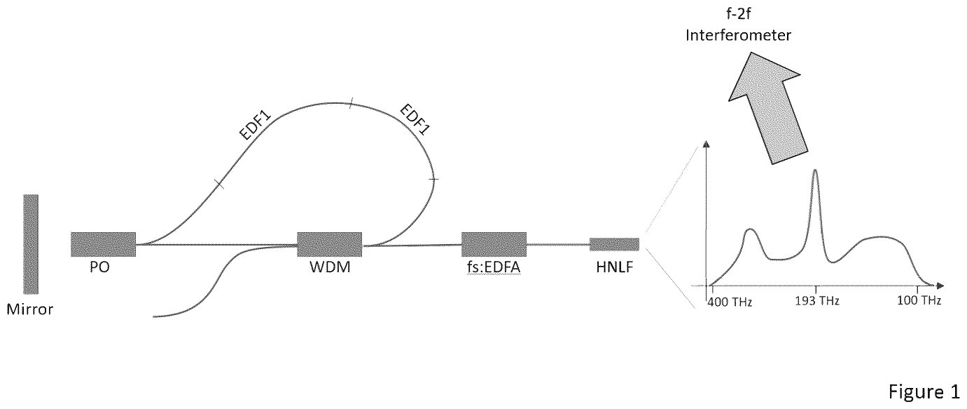

In order to achieve this goal, it was investigated, among other things, the dependence of the frequency of the pump power fixed point vfix_{,pump} on the pump power P, using the schematically illustrated embodiment example of a device according to the disclosure shown in FIG. 1. The central element is a femtosecond erbium fiber oscillator based on additive pulse mode locking (“Pulsmodenkopplung”). It consists of a non-linear amplifying loop mirror (abbreviated: NALM) with a short free beam section. The mode coupling device is formed by a closed loop of a light-conducting fiber. The fiber loop is at least partially formed by the laser-active medium. Repetition frequencies of up to 250 MHz can be realized in this compact system. An adjustable polarization optics (PO) in the linear part of the laser enables sensitive alignment of the non-reciprocal phase bias (“nichtreziproke Phasenverschiebung”). The use of polarization-maintaining optical fibers minimizes environmental interference. The laser resonator contains two sections EDF1, EDF2 of a light-conducting fiber doped with rare earth ions as the laser-active medium, which differ from each other in terms of group velocity dispersion (GVD). The dispersion of the laser resonator can be changed, for example, by adjusting the length ratio between the two different erbium-doped fiber sections EDF1 and EDF2. For example, the GVD of EDF1 can be normal, while the GVD of EDF2 is anomalous. In this way, any value for the dispersion of the laser resonator can be set. Alternatively, it is also conceivable that the laser resonator only has a single laser-active medium, whereby additional passive, possibly also adjustable components (gratings, prisms, etc.) are used to set the dispersion. “Mirror” refers to an end mirror of the laser resonator. WDM refers to a wavelength multiplexer. The pump light source is not shown in FIG. 1.

As can be seen in FIG. 1, the laser resonator is followed by a single-pass erbium fiber amplifier (fs:EDFA), which amplifies the output laser pulses to several nJ. Subsequently, a highly nonlinear fiber (HNLF) generates a supercontinuum ranging from 135 THz to 370 THz. Using f-2f interferometry in combination with the generation of the second harmonic, the carrier envelope frequency f_{CEO} can be determined in a known manner. In addition, individual comb lines can be superimposed with external reference frequencies in order to analyze the resulting beat signals with an HF spectrum analyzer, for example with regard to the linewidths (FWHM) of individual comb lines.

It should be noted that the disclosure can be implemented with all types of fs pulse laser systems. The disclosure is not limited to the laser design shown in FIG. 1.

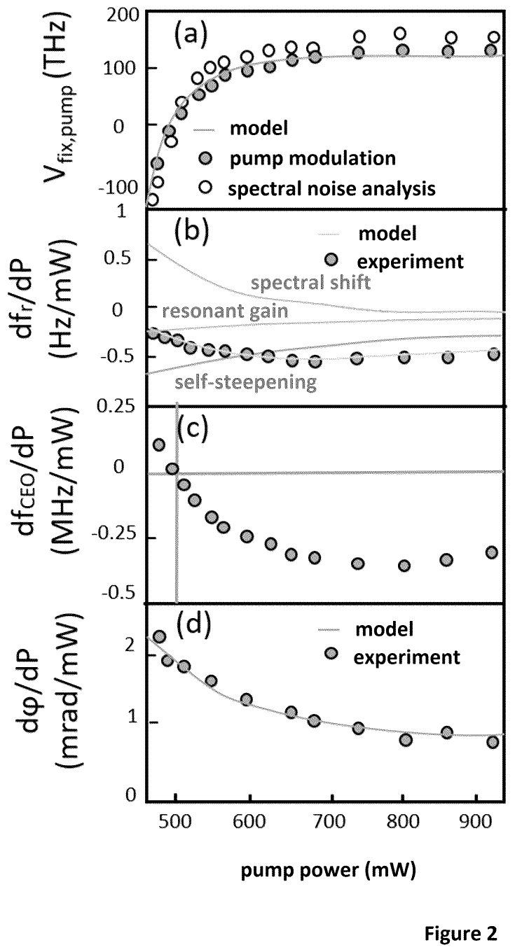

The results of the investigation of the pump power dependence are shown in FIG. 2. The data were determined by analyzing the noise spectra (circles) and by pump power modulation (dots). As can be seen in FIG. 2a, the pump power fixed point vfix_{,pump} varies over a range of approximately 300 THz, while the laser device maintains a stable pulsed operation. Negative fixed point frequencies for P<500 mW mean a movement of all real comb lines during fluctuations of the pump power without one of the comb lines remaining fixed in its position. The diagram illustrates that the pump power itself is a decisive parameter for the targeted selection of the pump power fixed point. In this respect, the width of spectral lines of the optical frequency comb can already be minimized by adjusting the pump power according to the disclosure.

Theoretically, the pump power fixed point is given by

$${v}_{fix , pump} = {v}_{c} + {f}_{r}^{2} \frac{d φ / dP}{d {f}_{r} / dP} .$$

Where ν_{c} and φ are the central frequency and the phase of the electromagnetic wave. The denominator on the right-hand side of the equation indicates the dependence of the repetition frequency fᵣ of the OFC on the pump power P. Variations in the pump power influence the repetition frequency in three ways:

$$\frac{d {f}_{r}}{d P} = - {f}_{r}^{2} ( \underbrace{{β}_{2 , cav} \frac{d {ω}_{c}}{dP}}_{spec . shift} + \underbrace{\frac{γ}{{ω}_{c}} \frac{d {A}^{2}}{d P}}_{self - steep .} + \underbrace{\frac{1}{{Ω}_{g}} \frac{dg}{dP}}_{res . gain} ) .$$

The first term on the right-hand side takes into account the spectral shift (“spektrale Verschiebung”) of the central angular frequency ω_{c}. This contribution scales with the group velocity dispersion (GVD) β_{2,cav} in the laser resonator.

Secondly, there is a pump power-induced change in the repetition frequency due to self-steepening (“Selbstversteilerung”) of the laser pulses, which depends on the peak intensity A² of the laser pulses and the non-linearity γ of the laser resonator, which in the case of a fiber laser is determined by the type of fiber, the fiber length per revolution in the laser resonator and the other elements of the laser resonator.

The contribution of the resonant gain (“Resonanzverstärkung”) is inversely proportional to the width of the optical gain spectrum Ω_{g}.

Overall, the analysis of the output spectrum and the power of the laser resonator makes it possible to calculate the pump power-induced change in the repetition frequency dfᵣ/dP. FIG. 2b shows the dependence of the pump power on the individual contributions to the above equation and their sum (solid curves).

Experimental access to dfᵣ/dP is made possible by slightly modulating the pump power and measuring fᵣ with a high-resolution frequency counter. These results (filled circles in FIG. 2b) are excellently represented by the model based on the above equation.

FIG. 2c shows the measurement of the pump power dependence of f_{CEO}. It can be seen here that the pump power dependence of f_{CEO} disappears at a pump power of approx. 500 mW for the laser device under investigation. The line width of f_{CEO} is extremely small at this pump power (see the intersecting lines shown in FIG. 2c). It has been found that the CEO linewidth, measured by f-2f interferometry as explained above, shows clear minima as a function of the pump power P for a normally dispersive laser resonator, while the CEO linewidth changes monotonically with anomalous resonator dispersion. The most extreme case occurs at a total dispersion of the laser resonator of +1100 fs², where the CEO linewidth drops to only 700 Hz (FWHM) at the said pump power of P=500 mW. To the inventors' knowledge, this is the smallest CEO linewidth ever observed for a free-running frequency comb fiber laser. From this it can be concluded that the laser resonator can for example be normally dispersive with the lowest possible total dispersion in order to achieve the lowest possible noise.

A pump power-induced change of f_{CEO} results from variation of both the repetition frequency fᵣ and the carrier phase φ:

$$\frac{d {f}_{CEO}}{d P} = \frac{{υ}_{c}}{{f}_{r}} \frac{d {f}_{r}}{d P} + {f}_{r} \frac{d φ}{d P}$$

By reversing this equation and adopting the experimental values for dfᵣ/dP and df_{CEO}/dP (FIG. 2b, c), dφ/dP is obtained. The results and calculated phase changes in relation to the pumping fluctuations

$$\frac{d φ}{d P} = \frac{γ}{4 π} \frac{{dA}^{2}}{dP}$$

are shown as filled circles or solid lines in FIG. 2d. vfix_{,pump} can now be calculated on this basis as a function of the pump power based on the above equations. This results in the solid curve in FIG. 2a. Alternatively, the pump power fix point can be determined by inserting the data obtained by modulating the pump power for dfᵣ/dP and do/dP into the equation for determining vfix_{,pump}. The consistency of this simple approach (dots) with the noise spectral analysis (circles) and the theoretical model (solid) curve is impressively demonstrated in FIG. 2a.

This shows that it is possible to set the pump power fixed point vfix_{,pump} of the OFC to a specific value by specifically adjusting the above-mentioned parameters of the laser resonator (dispersion, non-linearity, intensity of the laser radiation, resonant amplification) in accordance with the explained model. This allows the phase noise to be minimized at the specified useful frequency.

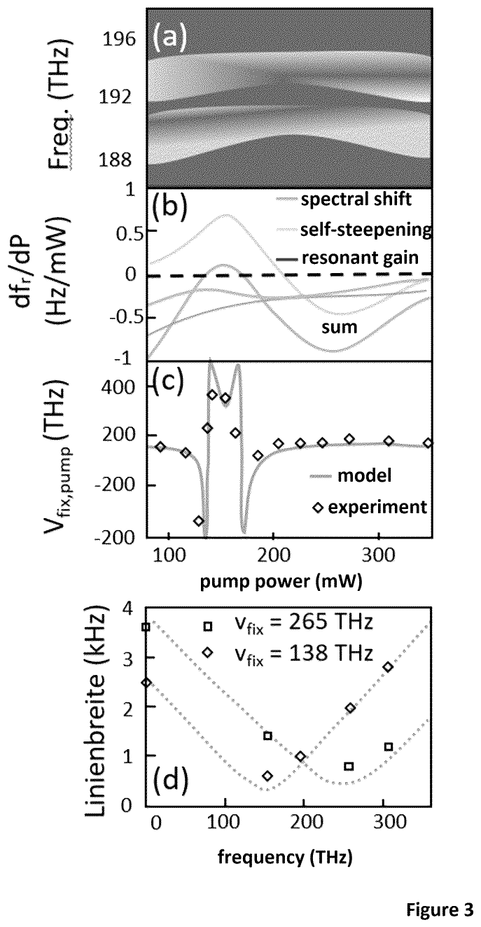

The output spectra of an exemplary laser resonator (group delay dispersion β_{2,tot}=−1300 fs², γ=4.1 kW⁻¹) are shown in FIG. 3a depending on the pump power. For P<210 mW, increasing the pump power shifts the laser pulses to higher central frequencies ν_{c}. FIG. 3b shows dfᵣ/dP as the sum of this spectral shift (“spektr. Versch.”), the resonant gain (“Resonanzverst.”) and the self-steepening (“Selbstversteil.”). The sum of all three contributions (“Summe”) is positive in a small range of 140 mW≤P≤170 mW (highlighted in FIG. 3b). Now these theoretical values and the calculated phase changes can be used to calculate the pump power fixed point vfix_{,pump} as a function of the pump power P according to the above model. FIG. 3c shows that the model (solid curve) is in excellent agreement with the experimental data from the experimental noise spectral analysis (diamonds). It is clear that vfix_{,pump} is not only above the central frequency ν_{c} for 140 mW≤P≤170 mW, but can also be varied between −150 THz and 400 THz during stable single-pulse operation.

As can be seen from the diagram in FIG. 3b, the pump power dependence of the repetition frequency dfᵣ/dP has in each case a zero point at a pump power of approx. 140 mW and 170 mW. At these zero points, the above formula for vfix_{,pump} therefore has a diverging pole point with a change of sign, as the diagram in FIG. 3c also shows. This means that the pump power fixed point near the respective zero point can be varied in a very wide range from below −150 THz to over 400 THz simply by adjusting the pump current. The pump power P can be for example adjusted in such a way that the pump power dependence of the repetition frequency fᵣ essentially disappears. In other words, the pump power P is set to a value closest to a zero point of dfᵣ/dP at which the pump power fixed point vfix_{,pump} assumes the desired value, i.e. at which the phase noise at the useful frequency is as low as possible.

Setting the fixed pump power point vfix_{,pump} is a first step in designing a laser device that generates an OFC with very low noise. To also achieve sharp comb lines in a wide spectral range, the increase in the width of the spectral lines of the OFC with increasing frequency distance of the spectral lines from the useful frequency should also be minimized, i.e. the curvature of the quadratic increase of the phase noise with the distance from the fixed point. In general, as mentioned above, the spectral density of the phase noise S_{Δν} of a comb line at the frequency ν is given by

$${S}_{Δν , v} ( f ) = {f}_{r}^{- 2} [ {{S}_{rep}^{quant} ( v - {v}_{c} )}^{2} + {S}_{rep}^{env} ( f ) {( v )}^{2} + {S}_{rep}^{pump} ( f ) {( v - {v}_{fix , pump} )}^{2} ]$$

With laser resonators that have almost zero dispersion and are characterized by high circulating powers and spectrally broad laser pulses, fluctuations in the repetition frequency Sᵣₑₚ^{quant} caused by increased spontaneous emission (ASE) are reduced to a minimum. The influence of ambient noise Sᵣₑₚ^{env} can be reduced by shielding the laser resonator, i.e. by mechanically decoupling the laser resonator from the environment (e.g. by passive or active damping). If possible, fluctuations in the repetition frequency Sᵣₑₚ^{quant} caused by increased spontaneous emission (ASE) and the influence of ambient noise Sᵣₑₚ^{env} should be minimized. The pump power-induced fluctuations of the repetition frequency then dominate. Their spectral noise density is given by

$${S}_{rep}^{pump} ( f ) = {S}_{RIN} {P}^{2} {( \frac{d {f}_{r}}{d P} )}^{2} \frac{1}{1 + {( f / {f}_{3 dB} )}^{2}}$$

SRIN refers to the relative intensity noise of the pump light source, which can be for example minimized, for example, by using modern laser diodes that are operated at high currents. In addition to such a low-noise pump light source, active stabilization of the pump power (e.g. by controlling the injection current of a laser diode used as a pump light source or by controlling an amplitude modulator connected downstream of the pump light source to control the pump power supplied to the laser resonator) can also be useful for noise reduction. A low-loss laser resonator, e.g. with highly efficient fiber components, keeps the pump power P moderate. f_{3dB} is the 3 dB cut-off frequency of the laser resonator, which is determined by the characteristic time constants of gain and losses. Minimizing the pump power dependence of the repetition frequency of the frequency comb dfᵣ/dP is for example important for low-noise operation. Therefore, one approach of the disclosure is to compensate for the effects of resonance amplification and self-steepening by adjusting the effect of the spectral shift via the dispersion of the laser resonator (see above equation for dfᵣ/dP). The measurement of dfᵣ/dP together with the output spectrum of the laser resonator determines whether the dispersion in the laser resonator needs to be increased or decreased. This fine tuning is done, for example, by slightly adjusting the fiber lengths of EDF1 and/or EDF2 (FIG. 1). The tuning may also be carried out by means of other (possibly adjustable) dispersive components of the laser device.

The above equation for the pump power-related spectral noise density shows that dfᵣ/dP should also be minimized in order to reduce the curvature of the quadratic increase of the pump power-induced phase noise. At the same time, according to the above explanations, the curve of dfᵣ/dP determines the pump power fixed point of the OFC and thus the spectral range with the narrowest linewidths.

The setting of vfix_{,pump} according to the disclosure is thus carried out for the purpose of minimizing the phase noise by for example setting the pump power in a range in which the pump power dependence of the repetition frequency dfᵣ/dP essentially disappears, i.e. close to a zero point of dfᵣ/dP as a function of the pump power P. In this range, vfix_{,pump} can be controlled over a wide range. At the same time, the increase in the width of the spectral lines of the optical frequency comb with the frequency distance of the spectral lines from the useful frequency is small. This means that the frequency comb has low noise in a wide range around the useful frequency. To ensure that the laser resonator has a zero crossing of dfᵣ/dP at a suitable pump power P, the dispersion of the laser resonator can be adjusted, for example, as explained above.

In one embodiment, the laser device according to the disclosure can have a control device which is intended to detect the width of one or more spectral lines of the frequency comb as a control variable and to control the pump power P of the pump light source as an actuating variable in such a way that the line width is kept to a minimum.

The disclosure proposes an optimization by varying at least two of the mentioned parameters (pump power, group delay dispersion of the laser resonator, nonlinearity of the laser resonator, gain of the laser active medium) in an iterative procedure until a solution is found in which the pump power fixed point is set to the value minimizing the phase noise at the useful frequency and at the same time the increase of the width of the spectral lines of the OFC with the frequency distance of the spectral lines from the fixed point frequency is minimal.

Three possible cases should be highlighted:

### Case 1: Generation of an Ultra-Stable Dispersive Wave

If laser radiation is to be generated specifically in the form of an ultra-stable dispersive electromagnetic wave, the useful frequency at which the phase noise is minimal should be greater than the central frequency ν_{c} of the frequency comb. The dominant noise contribution should also be vfix_{,pump}>ν_{c}. For this, dfᵣ/dP>0 must apply as a rule (assuming that the pump power dependence of the carrier phase is dφ/dP>0). According to the above equation, dfᵣ/dP is the sum of various pump power-dependent contributions (possibly also other contributions not considered in the equation, e.g. due to higher-order dispersion, TOD, etc.). If the course of dfᵣ/dP and ω_{c} is now measured as a function of the pump power, it can be determined whether and in which direction the group delay dispersion of the laser resonator (and thus primarily the pump power-dependent spectral shift) must be corrected. The contributions due to self-steepening and resonance amplification are hardly influenced by a fine adjustment of the dispersion. If dφ/dP<0, then dfᵣ/dP<0 must apply.

### Case 2: Generation of an Ultra-Stable Solitonic Wave

If laser radiation is to be generated specifically in the form of an ultra-stable solitonic electromagnetic wave, the useful frequency at which the phase noise is minimal should be lower than the central frequency ν_{c} of the frequency comb. The dominant noise contribution should also be vfix_{,pump}<ν_{c}. For this, dfᵣ/dP<0 must apply as a rule (assuming that the pump power dependence of the carrier phase is dφ/dP>0). If dφ/dP<0, then dfᵣ/dP>0 must apply.

### Case 3: Generation of an Ultra-Stable f_{CEO}-free OFC Through Differential Frequency Generation

If an f_{CEO}-free (f_{CEO}=0) OFC with a narrow line width of the comb lines is to be generated by nonlinear difference frequency generation (DFG), the CEO line width of the fundamental OFC (i.e. before the DFG) should be as small as possible. After amplification of the laser radiation of the fundamental OFC, generation of an octave-spanning supercontinuum and subsequent DFG from dispersive and solitonic frequency components, so that the central frequency of the OFC after the DFG corresponds again to the central frequency of the fundamental OFC, a spectral linewidth is obtained at the central wavelength of the OFC after the DFG that corresponds to the linewidth of the fundamental OFC at f_{CEo}. Therefore, in this case the pump power fixed point should be set close to 0 THz. As a rule (assuming that the pump power dependence of the carrier phase is dφ/dP>0), dfᵣ/dP>0 must apply.

The diagram in FIG. 3d shows an example of the line widths of two low-noise laser devices designed according to the scheme described. The repetition frequency is 40 MHz in each case. The laser devices are ideally suited for applications in the field of time-domain quantum physics. The first laser device (β_{2,tot}=+2800 fs² and γ=10.9 kW⁻¹) is optimized for the generation of laser pulses in the mid-infrared with ν_{fix,pump}=138 THz at P=38 mW. With this design, dfᵣ/dP=−0.14 Hz/mW was determined. Such low values for dfᵣ/dP and P promise ultra-narrow linewidths over a wide spectral range. The spectral purity of the previously used single-line reference light sources proved to be insufficient to characterize the frequency comb obtained. Therefore, a highly stable optical cavity of high quality and a linewidth <1.5 Hz was used for the measurement. The FWHM of the corresponding beat signals and the f_{CEO} linewidth are shown as diamonds in FIG. 3d. As can be seen in the diagram, the OFC has comb lines with linewidths below 3 kHz in a very broad spectral range of more than 300 THz, with an absolute minimum of only 600 Hz close to the fixed point frequency.

The second laser device (β_{2,tot}=+3100 fs² and γ=11.3 kW⁻¹) targets the frequency range above ν_{c}. With vfix_{,pump}=265 THz and dfᵣ/dP=+0.15 Hz/mW at P=30 mW, this laser device is ideally suited for time domain scanning in the near infrared, for example (squares in FIG. 3d).

The dotted lines in FIG. 3d represent the line widths calculated using the model explained above. These are in very good agreement with the measurements.

It should also be noted that the passive relative frequency stability of both laser devices is below 10⁻¹¹ over a measurement time of 123 ms in the entire optical range covered.

The disclosure thus demonstrates that a fibre-based laser device for generating an fs frequency comb with maximum passive stability (without coupling to a reference, without active stabilization) can be provided with a simple and compact design. The linewidths of the comb lines are in the sub-KHz range over a broad spectral range (>100 THz).

In an embodiment, the laser resonator is coupled to a non-linear optical element (HNF in FIG. 1), which is designed to broaden the spectrum of the laser radiation, for example to convert it into a supercontinuum. The narrow bandwidth of the comb lines is transferred to the spectral lines of the supercontinuum.

In a further embodiment, the laser resonator is stabilized with regard to the repetition frequency (fᵣ) of the frequency comb by coupling it to a high-frequency oscillator in the radio frequency range (e.g. atomic clock or 10 MHz reference of the GPS system) as a reference. The stabilization can, for example, be achieved in a known manner by means of a phase-locked loop that adjusts the resonator length of the laser resonator (using a piezo control element or similar). Even with this measure, i.e. without additional coupling to an optical reference, an ultra-stable OFC with a very narrow linewidth of the spectral lines in the range of the useful frequency can be realized according to the disclosure.

A use of the laser device according to the disclosure is for laser cooling, whereby the speed of movement of atoms of a gas or an atomic beam is reduced by exposure to a cw laser radiation which is stabilized with respect to frequency by coupling to the generated frequency comb. In the conventional way, for example, the cw laser radiation is superimposed with a comb line of the laser radiation of the laser device according to the disclosure, and a control signal is derived from the resulting beat signal by means of a controller (e.g. by mixing the beat signal with a high-frequency intermediate frequency signal), which sets the frequency of the cw laser radiation. This results in an extremely narrow line width of the cw laser radiation corresponding to the spectral lines of the OFC. This is achieved with comparatively little effort.

In quantum computers, quantum simulators, optical atomic clocks or other applications, there is a requirement to cool down a “hot” atomic beam and capture the neutral atoms or ions. Laser cooling is generally used for this purpose (Hänsch, T. W. & Schawlow, A. L. Cooling of gases by laser radiation. Opt. Commun. 13, 68-69, 1975), in which the atoms to be cooled are exposed to laser radiation. In order to realize a suitable laser cooling system, the laser source used must fulfill certain properties with regard to spectral linewidth and absolute stability.

Until now, the lasers used for laser cooling (with sub-MHz linewidths) have been stabilized at great expense, for example by locking them to optical references such as cavities, spectroscopy cells or wavemeters. Alternatively, the lasers used are coupled to a frequency comb as an optical reference in order to achieve stabilization to an absolute frequency. As a rule, however, the line widths of the comb lines of OFCs are too large in relation to the relevant narrow excitation energies of the atoms to be cooled, which are in the kHz range. One possible solution is an optically referenced OFC. In this case, the OFC is not coupled to a long-term stable high-frequency oscillator as a reference, but to an optical reference, such as a high-finesse cavity with sub-kHz (or in certain cases even sub-Hz) linewidth. Such optical references usually have excellent short-term stability, but suffer from long-term frequency drift. This means that an optically referenced OFC is very well suited for short-term stabilization, but absolute frequency stability over longer periods is only guaranteed to a limited extent and requires additional stabilization control loops or complex frequency drift corrections. One possible solution is simultaneous stabilization using a high-frequency reference and an optical reference (see DE 10 2017 131 244 B3). A corresponding laser system is complex, involves several control loops and references and is unsuitable for “hands-off” long-term operation, i.e. without constant intervention and continuous maintenance.

In contrast, the laser device according to the disclosure with the described setting of the pump power fixed point, in combination with a supercontinuum generation and a stabilization of the pulse repetition rate (and f_{CEO}) only by a high-frequency reference, enables the provision of a very compact, simple and cost-effective system for generating an OFC with a broad spectrum (supercontinuum) and at the same time very narrow line widths of the comb lines, which is very well suited as an optical reference for laser cooling in order to realize applications in quantum technology with cold atoms (quantum computers, quantum simulators, atomic clocks, etc.). The disclosure not only reduces the complexity of the system, but also the practical usability, long-term stability, system volume and—very significantly—the costs. For example, the “hands-off” usability due to the passive stability of the OFC plays a role, e.g. for remote stations in communications engineering or on satellites. The high passive stability of the OFC enables for example a much simpler design of the driver electronics compared to conventional systems. As the laser device is less sensitive to pump noise, significantly cheaper and more compact integrated current drivers can be used for the pump light source, depending on the specific stability requirements.

The laser device according to the disclosure can be used for the laser cooling of neutral atoms, such as Sr, Yb, Hg, Ca, Cd, Mg, Tm, or also ions, such as Yb⁺, Ca⁺, Sr⁺, In⁺, Ba⁺, Hg⁺, Al⁺+Mg⁺, Al⁺+Ca⁺, In⁺+Ca⁺.

The disclosure provides the generation of OFCs with narrow comb lines over a larger range of the spectrum.

1. Device for generating pulsed laser radiation, with a laser resonator containing a laser-active medium (EDF1, EDF2), a pump light source which optically pumps the laser-active medium (EDF1, EDF2) at a pump power (P), and a mode coupling device which is provided to effect phase coupling of the modes of the laser radiation circulating in the laser resonator, so that the spectrum of the laser radiation forms a frequency comb,
characterized in that
phase noise of the frequency comb, i.e. the width of spectral lines of the frequency comb, is minimized at a predetermined useful frequency by adjusting the frequency of the pump power fixed point (vfix_{,pump}) of the frequency comb.

2. Device according to claim 1, wherein the pump power (P) is dimensioned in such a way that the pump power dependence of the repetition frequency (fᵣ) essentially disappears.

3. Device according to claim 1, wherein the phase noise of the frequency comb at the useful frequency is minimized by one or more of the following measures:
mechanical decoupling of the laser resonator from the environment,
reduction of power losses of the laser radiation circulating in the laser resonator, for example by selecting loss-minimized optical components,
use of a low-noise pump light source,
active stabilization of the pump power (P),
adjustment of the pump power (P),
adjustment of the group delay dispersion of the laser resonator,
adjustment of the repetition frequency (fᵣ) of the frequency comb,
adjustment of the intensity of the laser radiation circulating in the laser resonator,
adjustment of the non-linearity of the laser resonator, and
adjustment of the amplification of the laser-active medium.

4. Device according to claim 1, wherein the increase in the width of the spectral lines of the optical frequency comb is minimized with the frequency spacing of the spectral lines from the useful frequency by adjusting the pump power dependence of the repetition frequency (fᵣ) of the frequency comb.

5. Device according to claim 4, wherein the pump power dependence of the repetition frequency (fᵣ) is minimized by at least one of the following measures:
adjustment of the group delay dispersion of the laser resonator,
adjustment of the intensity of the laser radiation circulating in the laser resonator,
adjustment of the non-linearity of the laser resonator, and
adjustment of the gain and/or the gain bandwidth of the laser-active medium.

6. Device according to claim 1, further comprising a control device which is intended to detect the width of one or more spectral lines of the frequency comb as a control variable and to control at least the pump power (P) of the pump light source.

7. Device according to claim 1, wherein the laser resonator is coupled to a non-linear optical element (HNLF) which is designed to broaden the spectrum of the laser radiation, for example to convert it into a supercontinuum.

8. Device according to claim 1, wherein the laser-active medium is formed by at least two sections (EDF1, EDF2) of a light-conducting fiber doped with rare earth ions, which differ from each other in terms of group velocity dispersion.

9. Device according to claim 1, wherein the mode coupling device comprises a non-linear optical loop mirror formed by a closed loop of an optical fiber.

10. Device according to claim 9, wherein the fiber loop is at least partially formed by the laser-active medium (EDF1, EDF2).

11. Device according to claim 1, wherein the laser-active medium (EDF1, EDF2) is non-linearly amplifying.

12. Device according to claim 1, wherein the laser resonator is stabilized with respect to the repetition frequency (fᵣ) of the frequency comb by coupling to a high-frequency oscillator as a reference.

13. Method of designing and/or operating a laser device comprising a laser resonator containing a laser-active medium (EDF1, EDF2), a pump light source which optically pumps the laser-active medium at a pump power (P), and a mode coupling device which is provided to effect phase coupling of the modes of the laser radiation circulating in the laser resonator so that the spectrum of the laser radiation forms a frequency comb,
characterized in that
phase noise of the frequency comb, i.e. the width of spectral lines of the frequency comb, is minimized at a predetermined useful frequency by adjusting the frequency of the pump power fixed point (vfix_{,pump}) of the frequency comb.

14. Method according to claim 13, wherein the laser resonator is designed such that the pump power dependence of the repetition frequency (fᵣ) as a function of the pump power has a zero point, wherein the pump power (P) is set such that the pump power dependence of the repetition frequency (fᵣ) virtually disappears.

15. Method according to claim 13, wherein the fixed point frequency is set by adjusting the pump power (P), preferably by regulation on the basis of the width of one or more spectral lines of the frequency comb as a control variable.

16. Method according to claim 13, wherein the phase noise of the frequency comb is minimized by one or more of the following measures:
mechanically decoupling the laser resonator from the environment,
reduction of power losses of the laser radiation circulating in the laser resonator, for example by selecting loss-minimized optical components,
use of a low-noise pump light source,
active stabilization of the pump power (P),
adjustment of the pump power (P),
adjustment of the group delay dispersion of the laser resonator,
adjustment of the repetition frequency (fᵣ) of the frequency comb,
adjustment of the intensity of the laser radiation circulating in the laser resonator,
adjustment of the non-linearity of the laser resonator, and
adjustment of the amplification of the laser-active medium.

17. Method according to claim 16, wherein the phase noise of the frequency comb is minimized by combined adjustment of the pump power (P) and the group delay dispersion of the laser resonator.

18. Method according to claim 13, wherein the increase of the width of spectral lines of the optical frequency comb with the frequency distance of the spectral lines from the fixed point frequency (vfix_{,pump}) is minimized by adjusting the pump power dependence of the repetition frequency (fᵣ) of the frequency comb.

19. Method according to claim 18, wherein the pump power dependence of the repetition frequency (fᵣ) is minimized by adjusting the group delay dispersion of the laser resonator.

20. Method according to claim 19, wherein the pump power dependence of the repetition frequency (fᵣ) is further minimized by at least one of the following measures:
adjustment of the intensity of the laser radiation circulating in the laser resonator,
adjustment of the nonlinearity of the laser resonator, and
adjustment of the gain and/or the gain bandwidth of the laser-active medium.

21. Method according to claim 13, wherein at least two of the parameters pump power (P), group delay dispersion of the laser resonator, nonlinearity of the laser resonator, gain of the laser active medium (EDF1, EDF2) are varied in an iterative process until the phase noise of the frequency comb at the useful frequency is minimized.

22. Use of a device according to claim 1 for laser cooling, wherein the speed of movement of atoms of a gas or of an atomic beam is reduced by exposure to a cw laser radiation which is stabilized with respect to the frequency by coupling to a comb line of the generated pulsed laser radiation.
